(19) United States
(12) Patent Application Publication
(10) Pub. No.: US 2023/0365165 A1
(43) Pub. Date: Nov. 16, 2023

(54) CONVEYOR DEVICE AND TREATMENT SYSTEM

(71) Applicant: Dürr Systems AG, Bietigheim-Bissingen (DE)

(72) Inventors: Michael KINCSES, Stuttgart (DE); Edgar BLUM, Grebenhain (DE); Mario REIBER, Sachsenheim (DE); Alexander LAUB, Fellbach (DE); Florian BRÄUNING, Stuttgart (DE)

(21) Appl. No.: 18/246,450

(22) PCT Filed: Sep. 23, 2021
(86) PCT No.: PCT/DE2021/100771

§ 371 Date: Mar. 23, 2023

(30) Foreign Application Priority Data
Sep. 25, 2020 (DE) 10 2020 212 124.9

(51) Int. Cl. B61B 3/02

(52) U.S. Cl. CPC B61B 3/02

(57) ABSTRACT

In order to provide a conveyor device for conveying workpieces which is of simple construction and offers flexible possibilities of use, it is proposed that the conveyor device comprise at least one carriage for receiving and conveying the workpieces, and a guide device for guiding the at least one carriage, wherein the guide device comprises a guide element on which the at least one carriage is guided in a sliding manner.

### RELATED APPLICATION

This application is a national phase of international application No. PCT/DE2021/100771, filed on Sep. 23, 2021, and claiming the benefit of German application No. 10 2020 212 124.9, filed on Sep. 25, 2020, both of which are incorporated herein by reference in their entirety and for all purposes.

### FIELD OF DISCLOSURE

The present invention relates to a conveyor device for conveying workpieces—for example, for conveying vehicle bodies. The conveyor device can be used in particular in a treatment system for carrying out treatment steps on the workpieces.

### BACKGROUND

Conveyor devices and treatment systems which comprise such conveyor devices are known, for example, from DE 10 2010 001 366 A1 and DE 10 2013 217 794 A1.

In the known conveyor devices, it is provided that a carriage for receiving and conveying the workpieces be able to be moved in a fixed rotational orientation along a guide rail or along a guide profile, and in particular on the top of the guide rail or the guide profile with respect to the direction of gravity. A rotatable workpiece holder, and in particular a pivot plate shaft, is arranged on the carriage, for example. The workpiece holder can, for example, additionally be pivotable, and in particular able to fold upwards, on the carriage, in particular in order to minimize a space requirement for the carriage together with the workpiece holder when no workpiece is arranged on the workpiece holder.

### SUMMARY

The object of examples disclosed herein is to provide a conveyor device for conveying workpieces which is simple to construct and can be used flexibly.

According to examples disclosed herein, this object is achieved by the features of independent claim 1.

The conveyor device for conveying workpieces is used in particular for conveying vehicle bodies.

The conveyor device preferably comprises at least one carriage for receiving and conveying the workpieces.

Furthermore, the conveyor device preferably comprises a guide device for guiding the at least one carriage. The guide device comprises in particular a guide element on which the at least one carriage is guided in a sliding manner. Preferably, exactly one guide element, and in particular one single guide rail or one single guide profile, is provided.

Furthermore, the conveyor device optionally comprises a rotation device by means of which the at least one carriage can be moved into different rotational orientations relative to the guide element.

In contrast to the prior art, the at least one carriage is thus preferably rotatable as a whole relative to the guide element, and thus can be moved into different rotational orientations relative to the guide element. In particular, a folding device for folding down a workpiece holder can preferably be dispensed with as a result.

The carriage is in particular arranged and/or formed so as to be rotatable about a central axis or longitudinal axis of a guide element portion of the guide element.

A workpiece holder for receiving a workpiece is preferably fixedly connected to the carriage and can be moved into different rotational orientations relative to the guide element by rotating together with the carriage.

The guide element is designed, for example, in the manner of a rail or profile, e.g., in the form of a hollow profile, wherein the carriage is preferably captively guided on the guide element in such a way that, apart from the change in the rotational orientation, it is movable only along the guide element.

It can be advantageous if the at least one carriage can be selectively moved into a receiving orientation and into a compact orientation by means of the rotation device. In the receiving orientation, at least one workpiece can be received and/or conveyed by means of the at least one carriage. In the compact orientation, an extension of the at least one carriage in at least one direction—in particular, in the horizontal direction—is reduced, and in particular minimized, in comparison with the extension in the receiving orientation.

In order to move the carriage and/or the workpiece holder from the receiving orientation into the compact orientation, the carriage—optionally, together with the workpiece holder—is preferably rotated by 90°.

The carriage preferably comprises the workpiece holder. Alternatively, it can be provided that the workpiece holder be arranged on the carriage, and in particular be fixed to the carriage in a non-detachable manner.

The at least one carriage preferably comprises one or more traction units, which preferably each comprise several traction rollers which roll over the guide element of the guide device.

In particular, multiple pairs or groups of three or more traction rollers are provided—in particular, on each traction unit—which are arranged around the guide element with respect to a circumferential direction of the guide element, in order to guide the carriage.

It may be expedient if different traction rollers, and in particular traction rollers which are different from each other, are used to bear the load in different rotational orientations of the carriage.

As an alternative or in addition thereto, it can be provided that different traction rollers, and in particular traction rollers which are different from each other, be used for the lateral guidance along the guide element in different rotational orientations of the carriage.

In particular, in one rotational orientation, one or more traction rollers can be used for bearing the load, and in a further rotational orientation, one or more further traction rollers can be used for bearing the load.

Furthermore, in one rotational orientation, one or more traction rollers can be used for the lateral guidance along the guide element, and in a further rotational orientation, one or more further traction rollers can be used for the lateral guidance along the guide element.

In particular, two or more traction rollers which are arranged offset from one another by at least approximately 90° and are alternately used as a support roller or as a lateral guide roller depending upon the rotational orientation can be provided. A further traction roller then preferably serves as a stabilizing roller, which is arranged, for example, offset by approximately 135° from the two other support rollers.

Preferably, two, three, or four such triplets of traction rollers are provided per traction unit, and/or two or more such traction units are provided per carriage.

Two or more traction units of one carriage are preferably movably coupled to one another—in particular, to enable traversing a corner and/or uphill travel and downhill travel of the carriage along the guide element.

It may be expedient if one or more traction rollers of the carriage are drive rollers for driving the carriage. In particular, one or more traction rollers serving as support rollers is/are coupled to or provided with a drive—in particular, an electric motor—for driving the carriage.

In this case, it can be provided that one or more rollers serving as support rollers and/or one or more rollers serving as lateral guide rollers be or be able to be permanently driven. Alternatively, it can be provided that only those traction rollers which serve as a support roller be or be able to be permanently driven.

In one embodiment of the invention, it can be provided that the rotation device comprise a rotary drive or a rotary guide, and in particular a slotted guide, by means of which the at least one carriage can be moved into different rotational orientations.

The carriage can be moved into different rotational orientations in particular by deflecting, raising, or lowering an end, facing away from the guide element, of the at least one carriage.

Alternatively or additionally, it can be provided that the at least one carriage be able to be moved into different rotational orientations by rotating a guide element portion of the guide element or by means of a twisted guide element portion.

By means of a rotation device, e.g., an end, facing away from the guide element, of the carriage, and in particular an end, facing away from the guide element, of a workpiece holder of the carriage, is moved in a circumferential direction around the guide element, e.g., raised or lowered by means of a lifting device or lifting arm device, and/or by moving the carriage along a slotted guide, because, for example, a roller rolls along a curved slotted guide on the end, facing away from the guide element, of the carriage—in particular, the workpiece holder.

The lifting arm device can comprise, for example, a lifting arm which can be raised and lowered by means of a rotary drive designed as a lifting arm drive.

The lifting arm engages, with its end remote from the lifting arm drive, in particular on a guide portion of a connecting element in order to selectively bring it into a horizontal orientation (receiving orientation) or into a vertical orientation (compact orientation).

The end of the lifting arm is provided, for example, with a bearing roller which rolls on the guide portion of the connecting element.

The connecting element preferably forms a fixed connection between the guide element—in particular, a rotatable guide element portion of the guide element—and a support for a counter roller of the carriage. By raising or lowering the lifting arm, preferably not only is the rotatable guide element portion, together with the carriage arranged thereon, rotatable as a whole, but also this rotation is preferably supported by a rotational movement of the support for the counter roller.

The rotatable guide element portion is preferably arranged, and in particular mounted, to be rotatable about its own longitudinal center axis.

The guide element is or preferably comprises a round tube. Alternatively, a guide element made of solid material can be formed, wherein the guide element is then in particular a round rod or comprises a round rod.

The guide element preferably comprises several guide element portions which are designed as a round tube or as a round rod or comprise a round tube or a round rod.

It may be expedient if the guide element comprises one or more linear guide element portions and one or more curved guide element portions.

In particular if the carriage comprises several traction rollers arranged one after the other along the guide element, the distance between the rollers may be increased during travel around corners. The guide element therefore preferably has a reduced diameter in one or more, and in particular in all, curved guide element portions—in particular, with respect to a diameter in one or more or all linear guide element portions.

The diameter in the one or more curved guide element portions is preferably at least approximately 0.5%, and in particular at least approximately 1%, smaller than a diameter in one or more or all linear guide element portions.

Alternatively or in addition to a round tube, it can be provided that the guide element be a square tube or a square rod, or comprise a square tube or a square rod.

In particular, it can be provided that the guide element comprise several guide element portions which are designed as a square tube or square rod, or comprise a square tube or a square rod.

A square tube or a square rod has in particular a rectangular cross-section, and in particular a square cross-section.

It can be advantageous if the at least one carriage comprises a traction drive and if the conveyor device comprises an energy supply device for supplying the traction drive with drive energy.

In particular, at least one traction roller can be driven by means of the traction drive in order to move the carriage along the guide element.

It can be advantageous if the energy supply device comprises an energy supply element which extends along the guide element of the guide device and can be moved into engagement with or is in engagement with an energy receiving element of the carriage.

The energy supply element is in particular a power rail.

The energy receiving element is, for example, a current collector, and in particular a sliding contact.

The energy receiving element is preferably arranged centrally between two or more than two traction rollers, and in particular centrally between two traction units, with respect to a conveying direction.

It may be expedient if the energy receiving element is arranged and/or is designed to be resiliently flexible and/or elastically flexible.

It may be expedient if the energy supply element and/or the energy receiving element can be moved into different rotational orientations or can be or are arranged in different rotational orientations along the guide element, and in particular in such a way that the energy supply element and the energy receiving element can be moved into engagement with one another or are in engagement with one another, when the at least one carriage is arranged in the receiving orientation and/or in the compact orientation and/or while the at least one carriage is moved from the receiving orientation into the compact orientation or from the compact orientation into the receiving orientation.

The energy supply element and the energy receiving element are preferably permanently in engagement with one another. When the rotational orientation of the carriage is changed, a change in the rotational orientation of the energy supply element and/or of the energy receiving element relative to the guide element and/or relative to the carriage preferably takes place.

A rotational orientation of the energy supply element can preferably be changed or be variable depending upon, and/or caused by, a movement of the carriage along the guide element, and/or depending upon, and/or caused by, a rotation of the carriage.

A rotational orientation of the energy receiving element can preferably be changed or be variable depending upon, and/or caused by, a movement of the carriage along the guide element, and/or depending upon, and/or caused by, a rotation of the carriage.

Alternatively or additionally, it can be provided that a rotational orientation of the energy supply element be changed or able to be changed independently of a movement of the carriage along the guide element and/or independently of a rotation of the carriage and/or by means of a drive unit provided separately for this purpose.

Alternatively or additionally, it can be provided that a rotational orientation of the energy receiving element be changed or able to be changed independently of a movement of the carriage along the guide element and/or independently of a rotation of the carriage and/or by means of a drive unit provided separately for this purpose.

It may be expedient if the guide element comprises several guide element portions, wherein one or more of these guide element portions is fixed in a rotationally-fixed manner on one or more support elements of the conveyor device, and/or wherein at least one guide element portion is designed and/or arranged to be able to rotate.

The at least one guide element portion is preferably rotatable about its longitudinal axis and/or central axis.

The longitudinal axis and/or the central axis of the at least one guide element portion is in particular parallel to the main extension direction of the at least one guide element portion—in particular, if the guide element portion is straight.

The at least one guide element portion is preferably rotatably mounted, by means of one or more bearings, and in particular one or more annular bearings, on one or more guide element portions which are rotationally fixed.

For example, it can be provided that the at least one guide element portion be rotatably mounted, by means of one or more plain bearings or ball bearings, on one or more guide element portions which are rotationally fixed.

The at least one rotatable guide element portion preferably extends into one or more guide element portions that are rotationally fixed. As an alternative or in addition thereto, it can be provided that one or more guide element portions which are arranged in a rotationally-fixed manner extend into the at least one rotatable guide element portion.

The one or more bearings preferably surround a guide element portion and are preferably surrounded by a further guide element portion.

The guide device preferably comprises a fixing device for rotatably fixing a rotatable guide element portion. The fixing device comprises in particular a multi-part bearing which engages around, and rotatably mounts, a bearing portion of the rotatable guide element portion.

Individual or multiple parts of the bearing are preferably individually removable in order to expose the bearing portion of the rotatable guide element portion, and thus to remove the rotatable guide element portion for maintenance purposes, for example.

The fixing device can, for example, form a component of a surface of the guide device coming into contact with the traction rollers of the carriage. The fixing device is then in particular itself fixed to a connecting element of the guide device in such a way that the surfaces of the fixing device are flush at least in sections with the surfaces of an adjacent, fixed guide element portion.

Alternatively, it can be provided in particular that the fixing device project into the bearing portion. The mounting accordingly takes place between an outer side of a part, protruding into the bearing portion of the rotatable guide element portion, of the fixing device and an inner side of the bearing portion of the rotatable guide element portion.

Furthermore, it can be provided that the fixing device comprise a cover element which engages around the bearing portion on the upper side thereof. The cover element is preferably removable in order to expose the bearing portion and, in particular, to allow removing it towards the top.

The at least one guide element portion designed and/or arranged to be rotatable preferably forms a rotation position of the conveyor device or is arranged in a rotation position of the conveyor device. In the rotation position of the conveyor device, the at least one carriage can preferably be moved relative to the guide element into different rotational orientations.

A guide element portion forming a rotation position is preferably rotationally fixed or rotatable, so that the at least one carriage is rotated relative to the at least one guide element portion, or so that the at least one carriage rotates together with the guide element portion relative to the guide element as a whole.

A rotatable guide element portion can be rotated passively, for example, by rotating the carriage with it. Alternatively, it can be provided that the guide element portion itself form a rotation device or be part thereof and be actively rotated—in particular, in order to achieve or at least support the movement of the at least one carriage into different rotational orientations.

The conveyor device described is particularly suitable for use in a treatment system.

The present invention therefore also relates to a treatment system for the treatment of workpieces, and in particular for treating the surface of vehicle bodies.

The treatment system preferably comprises a conveyor device, and in particular a conveyor device according to the invention.

It is preferably provided that the carriage comprise a workpiece holder, and in particular a pivot plate shaft, for receiving one or more workpieces.

The workpiece holder is preferably designed to be rotatable into a treatment container and/or out of a treatment container for the purpose of inserting and removing the one or more workpieces.

The workpiece holder is preferably arranged on the carriage and/or the traction units of the carriage so as to be rotationally fixed, in such a way that the workpiece holder is rotatable only together with the traction units about the guide element.

It can be advantageous if the guide device comprises one or more inclined portions along which the carriage and/or a workpiece arranged thereon can be brought to different height levels. In particular, it can be provided that the guide element have portions which are curved upwards or downwards in order to achieve different height levels and/or to enable the workpieces to be conveyed to different height levels.

By moving the carriage to different height levels, a drip angle for drying a workpiece, designed for example as a vehicle body, can be increased—in particular, without having to use an additional container.

Furthermore, it can be provided that a return of a circular guide device take place at a level which is different from that of the guidance along a treatment path—in particular, a higher level—such that, in particular, there can be more open surface area for positioning process assemblies—for example, pumps, filters, heat exchangers, etc.

As an alternative or in addition thereto, it can be provided that the guide element comprise one or more lowered levels, so that the carriage can be moved back from one end of a treatment path back to a beginning of a treatment path below the treatment system—in particular, when it is guided back to the start.

Preferably, the guide element is designed as a single rail or as a single profile, so that a particularly flexible path guide is possible.

One or more guide element portions are preferably connected to one another by means of a plug-in system. In this way, complex welding work can preferably be avoided.

It may be expedient if one or more guide element portions are each provided with one or more fixing elements—for example, straps.

The one or more fixing elements project in particular into a subsequent further guide element portion, and in particular such that the outer surfaces of the guide element portions are positioned and fixed so as to be flush relative to one another.

One or more fixing elements are welded, for example, into each of the respective guide element portions, so that the fixing elements lie in particular so as to overlap on adjacent guide element portions, and in particular on the respective inner sides of the guide element portions, in order ultimately to fix the outer sides of the guide element portions to be flush relative to one another.

Adjacent guide element portions are preferably fixed by means of connecting elements on one or more support elements of the guide device, wherein one or more connecting elements are preferably connected to one another, and in this case one or more compensating devices are provided for the flush positioning and fixing of the guide element portions.

One or more connecting elements for connecting the guide element to support elements of the guide device preferably extend in the vertical direction. The at least one carriage can then be guided past the connecting elements in particular in the receiving orientation.

Furthermore, it can be provided that one or more connecting elements for connecting the guide element to support elements of the guide device extend in an at least approximately horizontal direction. The at least one carriage can then be guided past these connecting elements in particular in the compact orientation.

In a rotation position, a rotatable guide element portion, for example, can be provided for changing the rotational orientation of the carriage.

The rotatable guide element portion can be connected, for example, by means of a shaft lifter in order to achieve a rotation.

It may be expedient if an energy supply element is rotatable together with the rotatable guide element portion in order to ensure the energy supply of the carriage before, during, and/or after the rotational movement.

As soon as a carriage has been rotated and has left the rotation position, the guide element portion is preferably rotated back into a starting position in order, in particular, to bring the energy supply element into a position which enables a further carriage to be brought in, while ensuring the energy supply thereof for rotation.

It may be expedient for the conveyor device to comprise one or more switch devices. For this purpose, it can be provided in particular that one or more guide element portions be designed to be pivotable or movable—in particular, in order to make different guide paths of the conveyor device accessible for the at least one carriage. As a result, the workpieces can in particular be routed selectively to different treatment paths.

The switch device is used in particular to be able to route the carriage selectively to different portions or regions of the guide device.

The switch device preferably comprises a switch element, which is in particular designed to be movable and can be moved into different positions in order to make different portions or regions of the guide device accessible to the carriage.

It can be advantageous if the switch element comprises two, differently-shaped, path portions, wherein, at any given time, always precisely one of the path portions can be coupled to one connection point. Depending upon the path portion selected for contact with the connection point, a connection to one of two further connection points is produced by means of the switch element.

The switch element can comprise, for example, a path portion which, in a first position of the switch element, serves to connect a treatment path to a return path. Such a path portion can, for example, be semi-circular.

Furthermore, the switch element can comprise, for example, a path portion which, in a second position of the switch element, serves to connect the treatment path to a maintenance path. Such a path portion can in particular be designed to be linear, or curved only in sections.

The switch element is preferably movable by a motor, and in particular can be moved selectively into the first position or the second position.

The movement of the switch element can take place on the one hand without carriages present. The switch element and thus the desired path portion are then in particular first moved into the desired position in order to create the connection for the subsequent movement of the carriage. Alternatively, however, it can also be provided that the carriage initially be positioned at the switch element, and in particular on the switch element, and then moved together with the switch element.

For example, it can be provided that the switch element comprise only one path portion which, together with the carriage, can selectively be moved into different positions in order to make different paths, and in particular a return path or a maintenance path, accessible to the carriage at different connection points.

The movement of the switch element—in particular, of the path portion together with the carriage arranged thereon—can take place, for example, at least approximately horizontally.

Alternatively, it can be provided that the movement of the switch element, and in particular of the path portion together with the carriage arranged thereon, take place, for example, at least approximately vertically.

It may be expedient for the conveyor device to be a climbing assistance device. The climbing assistance device is in particular an additional device for supplementing a traction drive of the carriage of the conveyor device, and in particular for optimizing the climbing behavior of the carriage—for example, when the guide element of the guide device is not exclusively horizontal.

The climbing assistance device may be a gear drive device, for example.

The drive of the carriage can generally be carried out, for example—in particular, in horizontal regions of the guide element—via one or more driven traction rollers. For this purpose, the one or more traction rollers must transmit a force by friction on the guide element. In particular, the friction may be insufficient for the transmission of force in inclined paths of the guide element. A positive force transmission from a traction drive of the carriage to a suitable counterpart may then be advantageous.

The gear drive device preferably comprises a gearwheel which can preferably be moved into engagement with a counterpart extending along the guide element—in particular, a drive rack.

The gearwheel can be coupled to the traction drive in particular by means of a coupling. In a horizontal operation of the carriage, the gearwheel can preferably be decoupled from the traction drive. As soon as the carriage approaches an inclined path, the gearwheel can be moved into engagement with the counterpart while still preferably turning. The coupling with the traction drive then preferably occurs—in particular, by automatic actuation and/or activation of the coupling—in order to subsequently transmit the drive force, required for driving the carriage, from the traction drive to the counterpart via the gearwheel. The carriage is then moved upwards, for example, along the inclined path.

The gearwheel and the counterpart are preferably sized in such a way that the traction roller rolling on the guide element can be driven without slipping and/or without brakes by means of the traction drive when the gearwheel is coupled. An effective diameter of the gearwheel preferably corresponds to an in particular smallest or average diameter of a running surface of the traction roller.

The gearwheel is in particular a sprocket.

Preferably, the gearwheel and a driven traction roller of the carriage are arranged on the same shaft, and can be driven by the same motor, and in particular the motor of the traction drive.

One or more traction rollers of the carriage are pressed or preferably can be pressed against the guide element of the guide device.

It can be provided that the gearwheel engage in the counterpart, and in particular the drive rack, from above with respect to the direction of gravity—in particular, when the carriage is arranged in the compact orientation.

The gearwheel is preferably designed such that the forces between the gearwheel and the counterpart act mainly in the conveying direction. Preferably, forces can thereby be minimized which could lead to lifting of the carriage, and in particular the traction rollers, off of the guide element.

It can be provided that a climbing travel of the carriage be carried out in a compact orientation thereof, i.e., with a substantially vertical orientation, or even when the orientation is oblique.

In one embodiment of the invention, it can be provided that the counterpart for the gearwheel be an element which is additionally arranged on or next to the guide element. In particular, the counterpart extends in parallel to the guide element.

Alternatively, it can be provided that the counterpart be integrated into the guide element or formed on the same. For example, the counterpart can be formed by a surface of the guide element, which surface is made to be complementary to the gearwheel at least in portions thereof.

In particular, a toothed rack can be integrated into the guide element.

The gearwheel and/or the counterpart are arranged and/or formed, for example, centrally on a traction roller, or on one side or on both sides directly next to the traction roller.

In an alternative embodiment, a chain can be provided as a counterpart. This chain can, for example, be arranged so as to extend along the guide element. A synchronization with the gearwheel can preferably be simplified by a spring-loaded arrangement.

Further preferred features and/or advantages of the invention form the subject matter of the following description and the drawings illustrating exemplary embodiments.

### BRIEF DESCRIPTION OF THE DRAWINGS

FIG. 1 is a schematic perspectival illustration of a further embodiment of a conveyor device for conveying workpieces;

FIG. 2 is a partial-cutaway perspectival illustration of the conveyor device of FIG. 1;

FIG. 3 is a schematic illustration of a rotation process for rotating a carriage of the conveyor device of FIG. 1;

FIG. 4 is a schematic vertical cross-section through the conveyor device of FIG. 1, wherein the carriage is arranged in a compact orientation;

FIG. 5 is a vertical cross-section corresponding to FIG. 4, wherein the carriage is arranged in a receiving orientation;

FIG. 6 is a schematic perspectival illustration of a guide element portion of a guide element of the conveyor device of FIG. 1;

FIG. 7 is an enlarged illustration of a connection region between two guide element portions, which must be connected to each other, of a guide element of the conveyor device of FIG. 1;

FIG. 8 is a schematic illustration, corresponding to FIG. 7, of the guide element portion in the assembled state;

FIG. 9 shows a schematic longitudinal section through a rotation position of a conveyor device, in which a rotatable guide element portion is provided;

FIG. 10 is a schematic perspectival illustration of an alternative embodiment of a guide element, in which a square tube is provided instead of a round tube;

FIG. 11 shows a sectional illustration, corresponding to FIG. 9, of a first alternative embodiment of a conveyor device, in which an optimized mounting of a rotatable guide element portion is provided;

FIG. 12 shows a sectional illustration, corresponding to FIG. 9, of a second alternative embodiment of a conveyor device, in which an optimized mounting of a rotatable guide element portion is provided;

FIG. 13 shows a sectional illustration, corresponding to FIG. 9, of a third alternative embodiment of a conveyor device, in which an optimized mounting of a rotatable guide element portion is provided;

FIG. 14 is a schematic plan view of a fifth alternative embodiment of a conveyor device, in which a switch device is provided, wherein a switch element is arranged in a first position;

FIG. 15 is a schematic plan view of the fifth alternative embodiment of FIG. 14, wherein the switch element is arranged in a second position;

FIG. 16 is a schematic plan view of a sixth alternative embodiment of a conveyor device, in which a switch device is provided, wherein a switch element is arranged in a first position;

FIG. 17 is a schematic plan view of the sixth alternative embodiment of FIG. 16, wherein the switch element is arranged in a second position;

FIG. 18 is a schematic plan view of a seventh alternative embodiment of a conveyor device, in which a switch device is provided, wherein a switch element is arranged in a first position;

FIG. 19 is a schematic plan view of the seventh alternative embodiment of FIG. 18, wherein the switch element is arranged in a second position;

FIG. 20 is a schematic plan view of an eighth alternative embodiment of a conveyor device, in which a switch device is provided, wherein a switch element is arranged in a first position;

FIG. 21 is a schematic plan view of the eighth alternative embodiment of FIG. 20, wherein the switch element is arranged in a second position;

FIG. 22 is a schematic side view of the eighth alternative embodiment of FIG. 20, wherein the switch element is arranged in the second position shown in FIG. 21;

FIG. 23 is a schematic perspectival illustration of a ninth alternative embodiment of a conveyor device, in which a gear drive device is provided; and

FIG. 24 is a schematic side view of a tenth alternative embodiment of a conveyor device, in which a lifting arm device is provided for rotating the carriage.

The same or functionally equivalent elements are provided with the same reference signs in all figures.

### DETAILED DESCRIPTION OF THE DRAWINGS

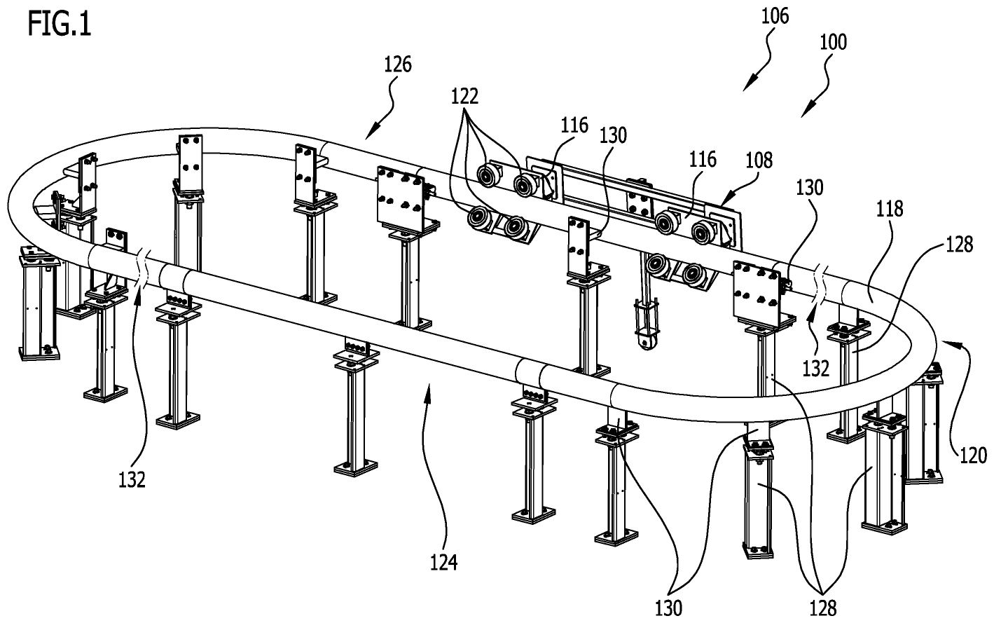

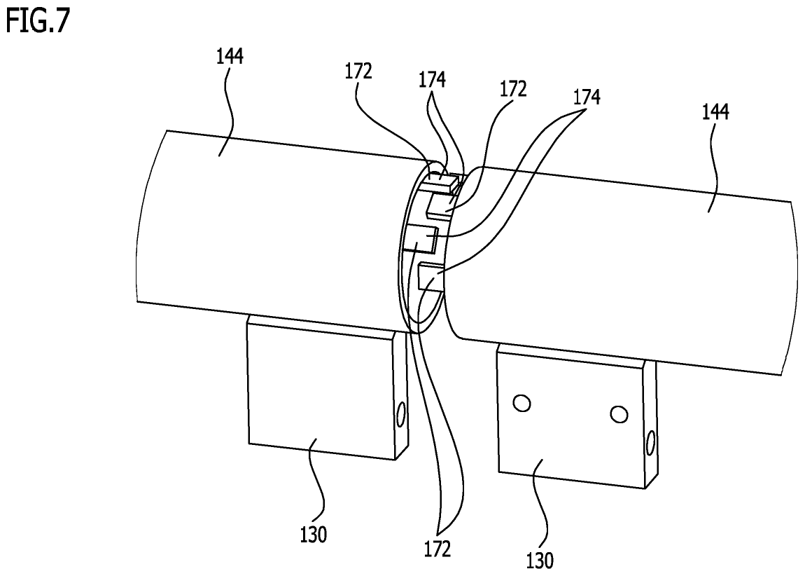

A first embodiment of a conveyor device, denoted as a whole by 100 in FIGS. 1 through 9, serves in particular to convey workpieces 102—for example, vehicle bodies 104.

The conveyor device 100 is in particular a component of a treatment system 106 for treatment of the workpieces 102. The treatment system 106 is, for example, an immersion treatment system.

The conveyor device 100 comprises a carriage 108 which comprises a workpiece holder 110 for receiving a workpiece 102.

The workpiece holder 110 comprises in particular a pivot plate shaft on which a workpiece 102 is rotatably held in order to be able to bring the workpiece 102 into a treatment container (not shown) or bring it back out of the same by rotating it about an axis of rotation 114.

The carriage 108 further comprises one or more, e.g., exactly two, traction units 116 by means of which the carriage 108 can be moved along a guide element 118 of a guide device 120 of the conveyor device 100.

Each traction unit 116 preferably comprises several traction rollers 122 which guide the respective traction units 116 on the guide element 118 in such a way that the traction units 116 can be moved exclusively along the guide element 118. In addition, each traction unit 116, and in particular the entire carriage 108, can be rotated about the guide element 118, and in particular can be into different rotational orientations relative to the guide element 118.

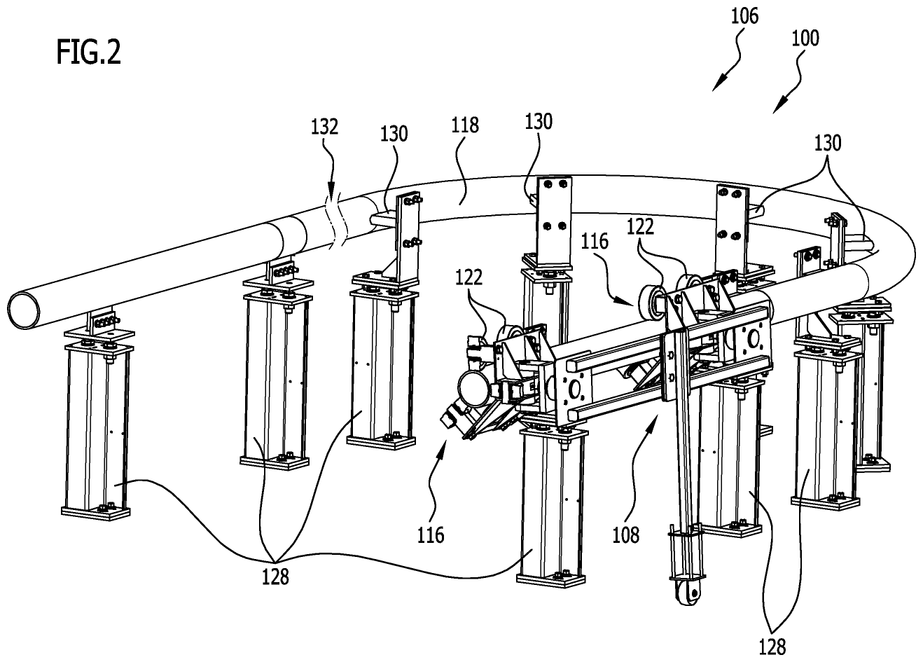

In the embodiment of the conveyor device 100 shown in very simplified form in FIGS. 1 and 2, it comprises a treatment path 124 and a return path 126.

The treatment path 124 is for the treatment of the workpieces 102, wherein the workpieces 102 can be conveyed for this purpose along the treatment path 124 by means of the carriage 108.

The return path 126 serves to return the carriage 108 after a treatment is carried out on the treatment path 124.

The workpieces 102 are arranged on the carriage 108 at the beginning of the treatment path 124, and are removed from the carriage 108 at the end of the treatment path 124.

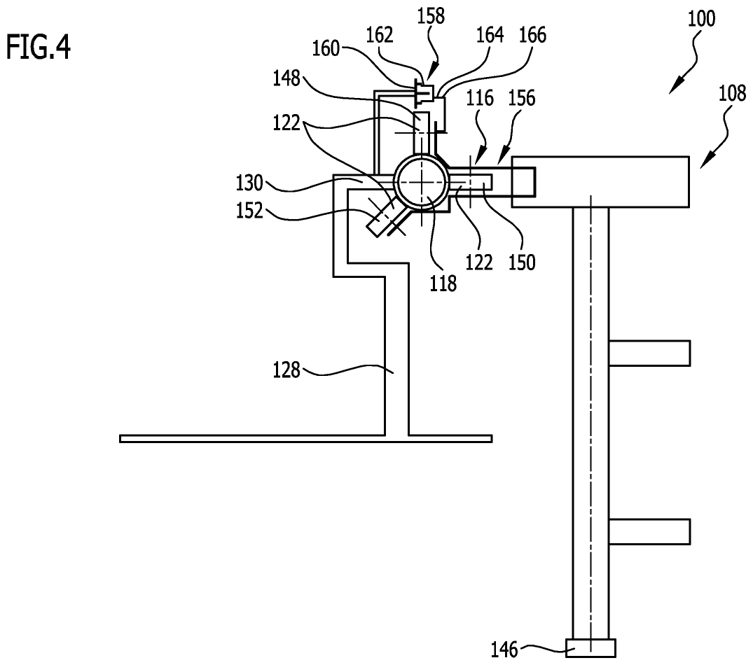

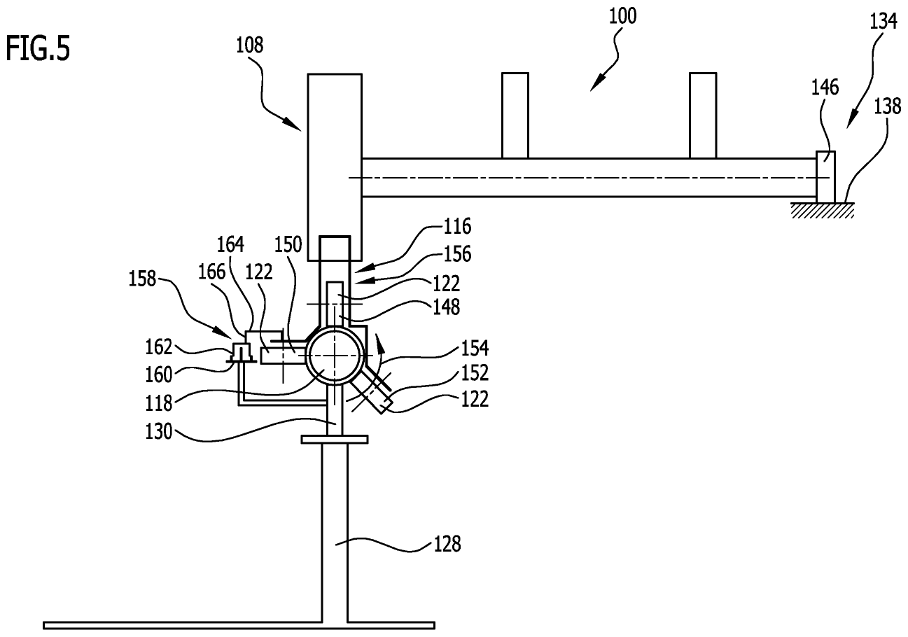

As can be seen in particular from a comparison of FIGS. 4 and 5, the carriage 108 together with the associated workpiece holder 110 can be arranged in different rotational orientations, wherein, according to FIG. 5, a receiving orientation for receiving a workpiece 102 is provided. The carriage 108 is arranged in this receiving orientation in particular when a workpiece 102 is conveyed along the treatment path 124.

Furthermore, the carriage 108 can be arranged in the compact orientation shown in FIG. 4. In the compact orientation, no workpiece 102 is arranged on the carriage 108. Rather, the compact orientation is used for the return along the return path 126, to allow for subsequently carrying out a new reception of a workpiece and treatment of the workpiece.

The guide element 118 for guiding the carriage 108 is fixed in particular by means of support elements 128, and in particular fixed relative to a floor.

The support elements 128 are, for example, supports or support pillars.

As can be seen in particular from FIG. 1 and from FIGS. 4 and 5, the different rotational orientation of the carriage 108 results in a potential overlap between the conveying contour or movement contour of the carriage 108, when it is moved along the guide element 118 in different rotational orientations, and the components for fixing the guide element 118.

The guide element 118 is therefore held on the support elements 128 by means of different connecting elements 130, wherein the connecting elements 130 project from different directions towards the guide element 118.

For example, connecting elements 130 protruding substantially vertically from below to the guide element 118 are provided. Furthermore, connecting elements 130 protruding substantially horizontally laterally to the guide element 118 are provided, for example.

As can be seen in particular from FIGS. 4 and 5, the carriage 108 can be guided past substantially vertical connecting elements 130 in particular in the receiving orientation, whereas the carriage 108 can be moved past connecting elements 130 arranged substantially horizontally in the compact orientation.

The conveyor device 100 comprises one or more rotation positions 132 at which the carriage 108 can be moved into different rotational orientations.

In FIG. 1, the two rotation positions 132 shown therein are shortened so as to simplify the illustration.

The rotation positions 132 separate in particular those regions of the conveyor device 100 from one another where connecting elements 130 are arranged which project differently towards the guide elements 118, such that, in the rotation positions 132, the orientation of the carriage 108 must be changed in order for it to be moved further along the guide element 118.

The rotational orientation is preferably changed by means of a rotation device 134 of the conveyor device 100.

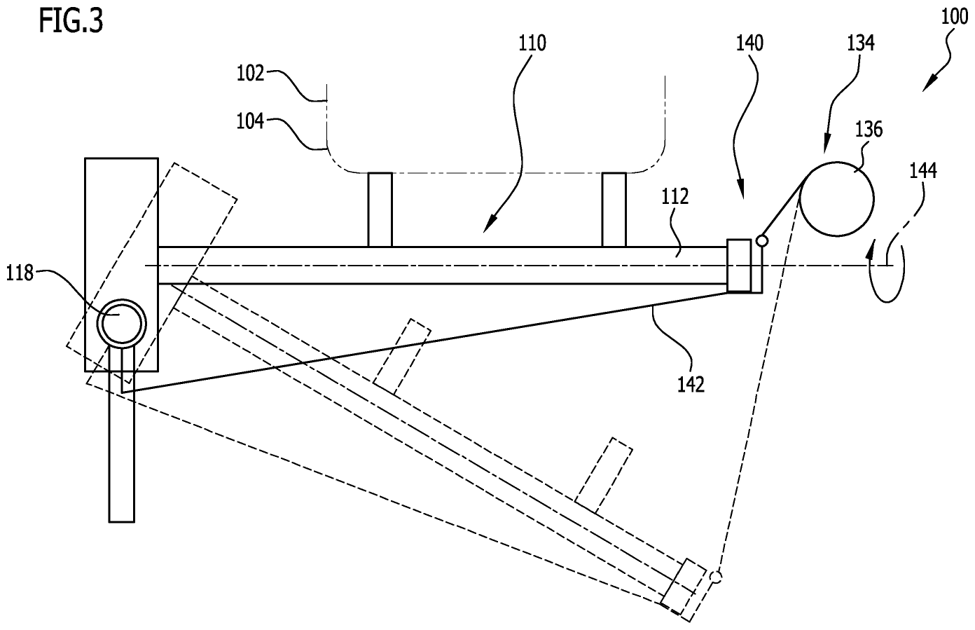

The rotation device 134 comprises in particular a rotary drive 136 (see FIG. 3) and/or a slotted guide 138 (see FIG. 5).

By means of the rotation device 134, in particular an end 140 of the carriage 108, and in particular of the workpiece holder 110, e.g., of the pivot plate shaft 112, which end faces away from the guide element 118, can be raised or lowered in order ultimately to move the carriage 108 as a whole into different rotational orientations relative to the guide element 118.

One or more connecting elements 142 are preferably used to fix the end 140 of the workpiece holder 110 to the traction units 116 of the carriage 108 in order to establish a firm connection to the traction unit 116 and/or a co-rotating connection to a guide element portion 144.

At the end 140 of the carriage 108—in particular, of the workpiece holder 110—a counter roller 146 is arranged, for example, which can roll in particular over a slotted guide 138 in order to bring about the change in the rotational orientation of the carriage 108.

As can be seen in particular from FIGS. 4 and 5, the carriage 108 comprises different traction rollers 122 which have different functions—in particular, depending upon which rotational orientation the carriage 108 has assumed.

In particular, provision is made in this case for at least one of the traction rollers 122 to form a support roller 148 to bear the weight of the carriage 108 in each rotational orientation.

A further traction roller 122 forms a lateral guide roller 150. In addition, a stabilizing roller 152 is preferably provided, so that ultimately at least three, or exactly three, traction rollers 122 are always arranged so as to be distributed around the guide element 118 along the circumferential direction 154 of the guide element 118 in order to ensure reliable guidance of the carriage 108 on the guide element 118.

An angle between the lateral guide roller 150 and the support roller 148 is preferably at least approximately 90°.

An angle between the stabilizing roller 152 and the support roller 148 and/or an angle between the stabilizing roller 152 and the lateral guide roller 150 is preferably at least approximately 135°.

When the carriage 108 is moved from the receiving orientation (FIG. 5) into the compact orientation (FIG. 4), the function of the traction rollers 122 changes in such a way that the traction roller 122 which initially serves as a support roller 148 takes over the function of the lateral guide roller 150, while the traction roller 122 which initially forms the lateral guide roller 150 becomes the support roller 148.

The stabilizing roller 152 continues to remain a stabilizing roller 152.

Preferably, each carriage 108 comprises several traction units 116, each comprising one or two, or more than two, groups of at least three, or exactly three, traction rollers 122, wherein each group preferably comprises a support roller 148, a lateral guide roller 150, and a stabilizing roller 152.

The carriage 108 is preferably designed to be self-propelled and comprises a traction drive 156—for example, an electric motor.

The traction drive 156 acts in particular on one or more traction rollers 122, and in particular on at least one traction roller 122, which serves at least temporarily as a support roller 148.

In order to supply the traction drive 156 with, in particular, electrical energy, the conveyor device 100 preferably comprises an energy supply device 158.

The energy supply device 158 comprises in particular an energy supply element 160, e.g., a power rail 162, and an energy receiving element 164—in particular, a sliding contact 166.

The energy supply element 160 is in particular arranged on the guide element 118 and engages with the energy receiving element 164 arranged on the carriage 108.

Since the carriage 108 must always be supplied with energy in the different rotational orientations in order to ensure its being driven, the energy supply element 160 and/or the energy receiving element 164 are preferably arranged and/or designed so as to be rotatable and/or pivotable, or are shaped in such a way that a movement of the carriage 108 along the circumferential direction 154 of the guide element 118 does not lead to any contact interruption—in particular, with simultaneous movement along the guide element 118.

The carriage 108 can thus be moved in a first orientation to a rotation position 132, can be rotated there, and can then continue along the guide element 118.

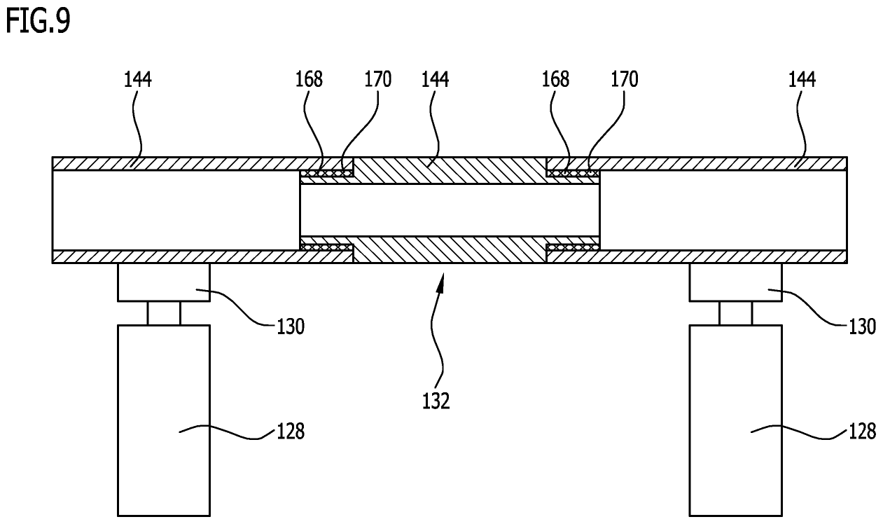

As can be seen in particular from FIG. 9, it can be provided that a rotation position 132 comprise a guide element portion 144 or be formed by it, the same being rotatably arranged, and in particular mounted, on one or more further guide element portions 144.

For this purpose, in particular one or more bearings 168, and in particular plain bearings 170, are provided.

The rotatable guide element portion 144 enables in particular a complete reception of the carriage 108, so that the modification of the rotational orientation of the carriage 108 can take place together with a rotation of the guide element portion 144. As a result, the forces occurring between the carriage 108 and the guide element 118 during the change of the rotational orientation can be minimized, and, moreover, abrasion of the traction rollers 122 can be prevented.

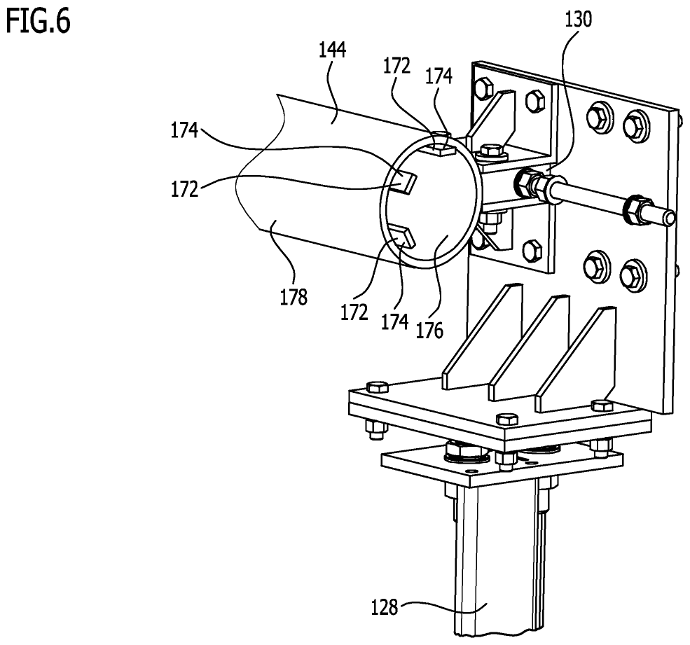

The remaining guide element portions 144, which are in particular not part of a rotation position 132, but, rather, are connected immovably to one another, are preferably detachably connected to one another, e.g., screwed together, wherein one or more fixing elements 172 are preferably provided for the flush arrangement of the guide element portions 144 with one another (see in particular FIGS. 6 through 8).

One or more fixing elements 172 are designed, for example, as straps 174 and are arranged, for example, on one or more guide elements 118 designed as a round tube, in such a way that the fixing elements 172 rest against inner sides 176 of mutually adjacent guide element portions 144. In particular, this ensures that outer sides 178 of the guide element portions 144 are flush with one another.

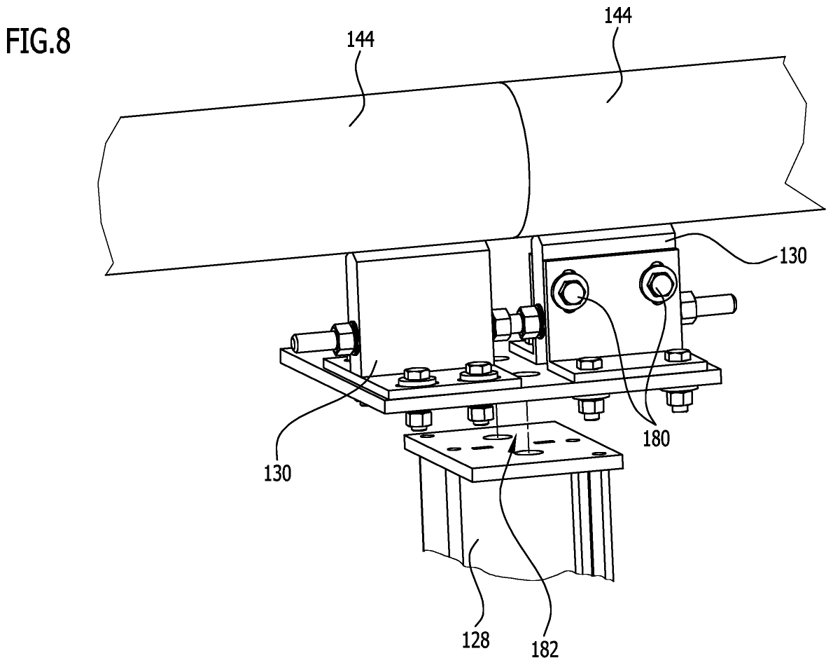

As can also be seen from FIG. 8, several connecting elements 130 can preferably be assigned to one shared support element 128.

Preferably, a height compensation 180 and/or a height adjustment 182 is provided at connecting points between two guide element portions 144.

In particular, screw connections with elongated holes, threaded rods, etc., can be used for this purpose in order ultimately to position the guide element portions 144 relative to one another and relative to the support element 128.

Because the guide element portions 144 can be fixed relative to one another by screwing and by using the fixing elements 172, the guide device 120, and thus also the conveyor device 100, can preferably be produced in a particularly simple and cost-effective manner. In particular, complex welding on-site is not necessary.

An alternative embodiment of a guide element 118 shown in FIG. 10 can be used instead of the guide element 118 shown in FIGS. 1 through 9. The guide element 118 shown in FIG. 10 is in particular not a round tube, but, rather, a square tube.

The outer side 178 of the guide element 118 therefore makes possible in particular a large-area contact of the traction rollers 122.

As can be seen from FIG. 10, the guide element 118 designed as a square tube is twisted at least in portions. In this way, rotation positions 132, in particular, can be created if the twisted configuration of the guide element 118 causes the traction rollers 122 and thus the entire carriage 108 to rotate on the guide element 118 as it rolls along.

Outside the rotation position 132, the guide element 118 designed as a square tube is preferably not twisted, so that a uniform guidance of the carriage 108 is possible without changing the rotational orientation.

Moreover, the other features mentioned above of a conveyor device 100 or treatment system 106 are also conceivable when using guide elements 118 designed as a square tube, since, for example, rotatable guide element portions 144 according to FIG. 9 are also possible with square tubes, if corresponding inserts on transition regions are used.

Due to the fact that, in the described embodiments of the conveyor device, the carriage 108 as a whole can be moved into different rotational orientations relative to the guide element 118, the entire conveyor device 100 can be constructed in a simple manner and flexibly adapted to different requirements.

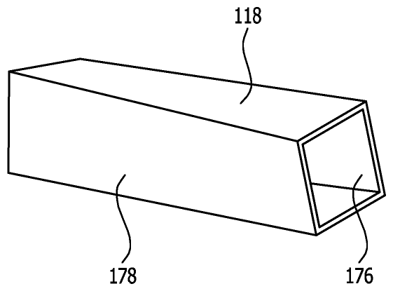

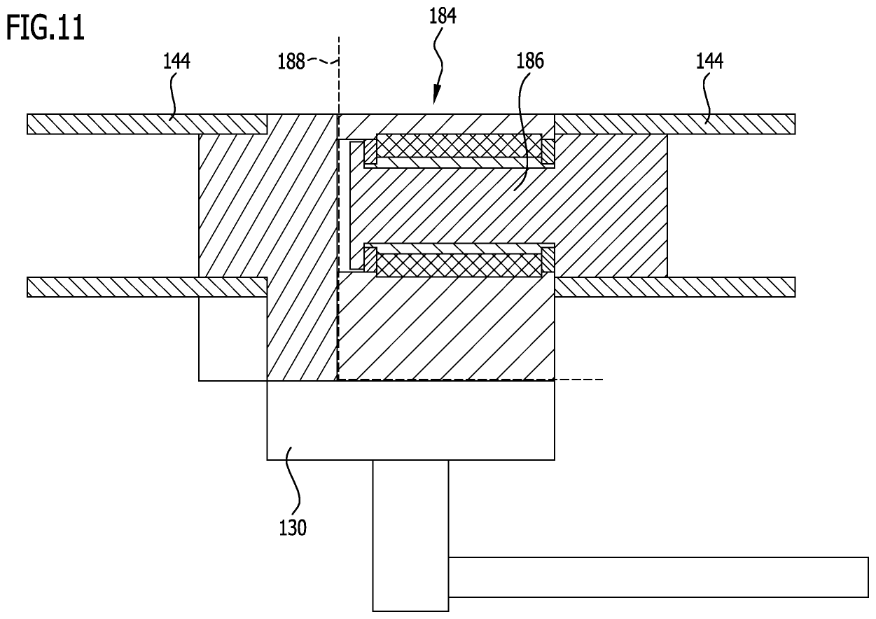

A first alternative embodiment of a conveyor device 100 shown in FIG. 11 differs from the embodiment shown in FIGS. 1 through 9 essentially in that a rotatably-mounted guide element portion 144 is detachably fixed to one or more support elements 128 and/or connecting elements 130 using a fixing device 184 with optimized assembly and/or disassembly.

For this purpose, the fixing device 184 comprises in particular a multi-part bearing 168 which surrounds a bearing portion 186 of the rotatable guide element portion 144 and supports it while allowing rotation.

Individual or multiple parts of the bearing 168 are preferably individually removable in order to expose the bearing portion 186 of the rotatable guide element portion 144, and thus to remove the rotatable guide element portion 144 for maintenance purposes, for example.

The fixing device 184 can, for example, form a component of a surface of the guide device 120, which surface comes into contact with the traction rollers 122 of the carriage 108. The fixing device 184 is then in particular itself fixed to the connecting element 130 in such a way that the surfaces of the fixing device 184 are flush at least in sections with the surfaces of the adjacent, stationary guide element portion 144.

As is indicated in FIG. 11 by the dashed dividing line 188, it can also alternatively or additionally be provided that the fixing device 184 be removable along the separating line 188 as a whole from the connecting element 130—in particular, in order to carry out a maintenance process. The removal of the fixing device 184 together with the rotatable guide element portion 144 arranged thereon preferably takes place without any other disassembly of the guide device 120.

Otherwise, the embodiment of the conveyor device 100 shown in FIG. 11 corresponds in terms of structure and function to the embodiment shown in FIGS. 1 through 9, such that reference is made to the above description thereof.

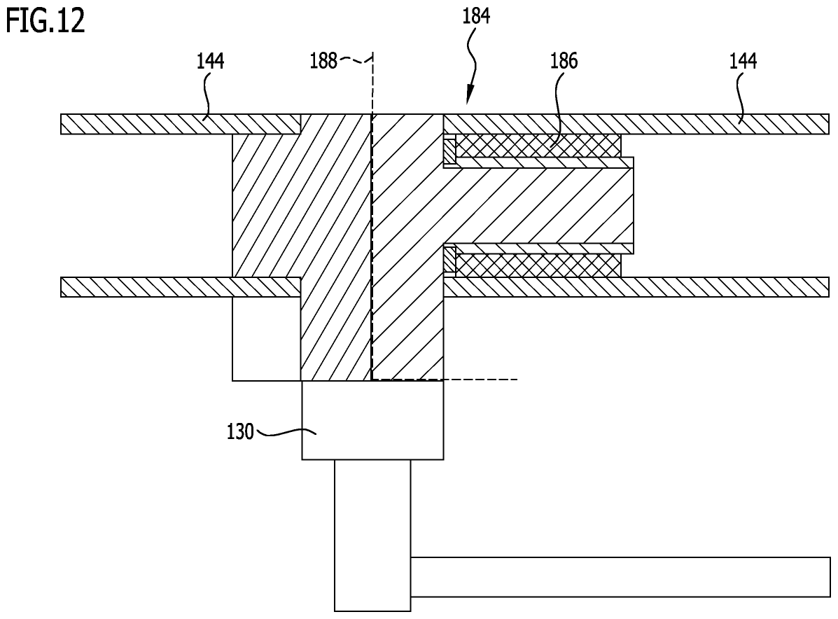

A second alternative embodiment of a conveyor device 100 illustrated in FIG. 12 differs from the embodiment shown in FIG. 11 essentially in that the fixing device 184 does not surround the bearing portion 186 of the rotatable guide element portion 144, but, rather, projects into the latter. The mounting accordingly takes place between an outer side of a part, protruding into the bearing portion 186 of the rotatable guide element portion 144, of the fixing device 184 and an inner side of the bearing portion 186 of the rotatable guide element portion 144.

Otherwise, the embodiment of the conveyor device 100 shown in FIG. 12 corresponds in terms of structure and function to the embodiment shown in FIG. 11, such that reference is made to the above description thereof.

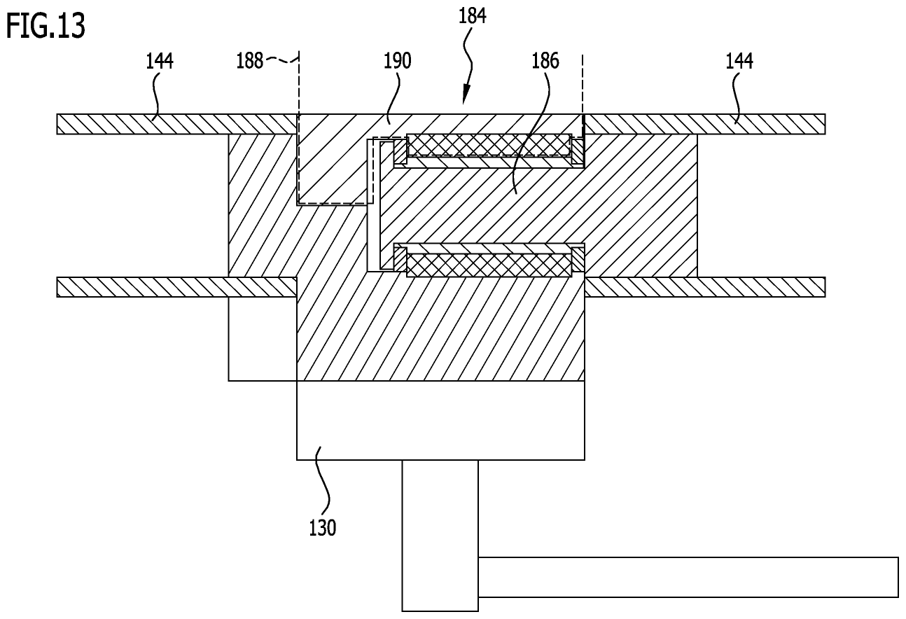

A third alternative embodiment of a conveyor device 100 shown in FIG. 13 differs from the embodiment shown in FIG. 11 substantially in that the fixing device 184 comprises a cover element 190 which surrounds the bearing portion 186 on the upper side thereof. The cover element 190 is removable, so as to expose the bearing portion 186 and, in particular, to be able to remove it upwards.

Otherwise, the embodiment of the conveyor device 100 shown in FIG. 13 corresponds in terms of structure and function to the embodiment shown in FIG. 11, such that reference is made to the above description thereof.

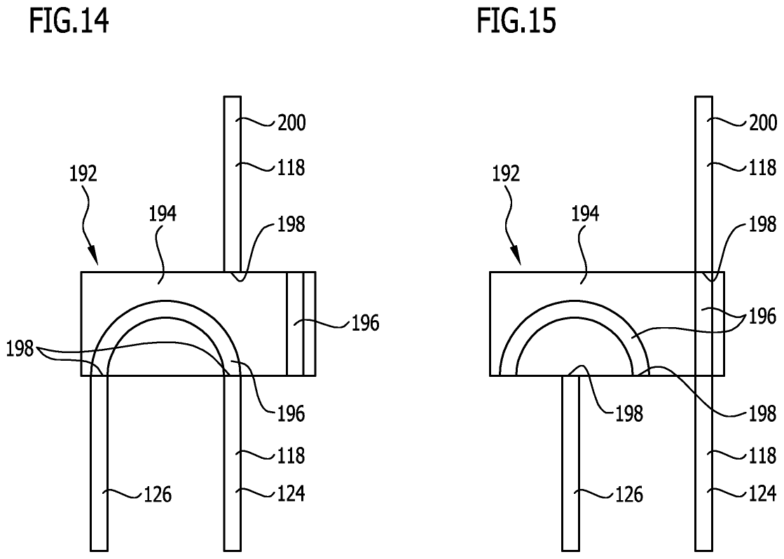

FIGS. 14 and 15 show a fifth alternative embodiment of a conveyor device 100, which differs from the embodiment shown in FIGS. 1 through 9 essentially in the presence of an optional switch device 192.

The switch device 192 serves in particular to be able to route the carriage 108 selectively to different portions or regions of the guide device 120.

For this purpose, the switch device 192 comprises a switch element 194, which is in particular designed to be movable and can be moved into different positions in order to make different portions or regions of the guide device 120 accessible to the carriage 108.

In the embodiment shown in FIGS. 14 and 15, it is provided that the switch element 194 comprise two, differently-shaped, path portions 196, wherein, at any given time, always precisely one of the path portions 196 can be coupled to one connection point 198. Depending upon the path portion 196 selected for contact with the connection point 198, a connection to one of two further connection points 198 is thereby produced by means of the switch element 194.

The switch element 194 can comprise, for example, a path portion 196 which, in a first position of the switch element 194, serves to connect a treatment path 124 to a return path 126. Such a path portion 196 can in particular be semi-circular (see FIG. 14).

Furthermore, the switch element 194 can comprise, for example, a path portion 196 which, in a second position of the switch element 194, serves to connect the treatment path 124 to a maintenance path 200. Such a path portion 196 can in particular be linear (see FIG. 15).

The switch element 194 can preferably be moved by a motor, and in particular selectively, into the first position or the second position.

Otherwise, the embodiment of the conveyor device 100 shown in FIGS. 14 through 15 corresponds in terms of structure and function to the embodiment illustrated in FIGS. 1 through 9, such that reference is made to the above description thereof.

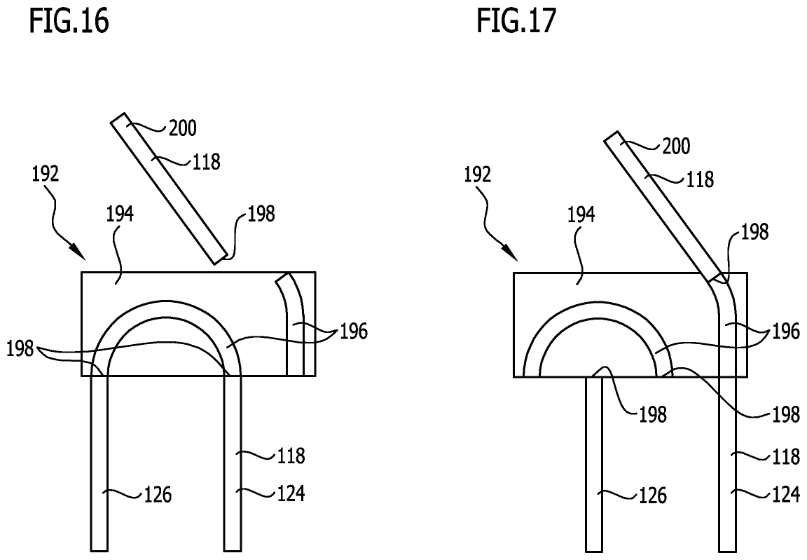

FIGS. 16 and 17 show a sixth alternative embodiment of a conveyor device 100, which differs from the embodiment shown in FIGS. 14 through 15 essentially in a different shape of one of the path portions 196 of the switch element 194.

The linear path portion 196 in this case is curved in portions thereof, and thus connects the treatment path 124 to a maintenance path 200 running obliquely thereto.

Otherwise, the embodiment of the conveyor device 100 shown in FIGS. 16 through 17 corresponds in terms of structure and function to the embodiment illustrated in FIGS. 14 through 15, such that reference is made to the above description thereof.

In the embodiments of the switch devices 192 shown in FIGS. 14 through 17, the movement of the switch element 194 takes place without carriages 108 present. The switch element 194 and thus the desired path portion 196 are first moved into the desired position in order to create the connection for the subsequent movement of the carriage 108.

Alternatively, however, it can also be provided that the carriage 108 initially be positioned at the switch element 194, and in particular on the switch element 194, and be subsequently moved together with the switch element 194.

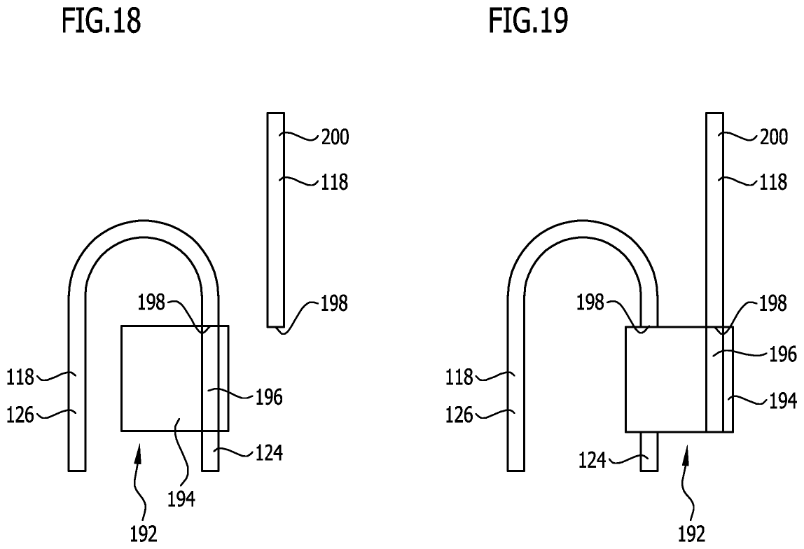

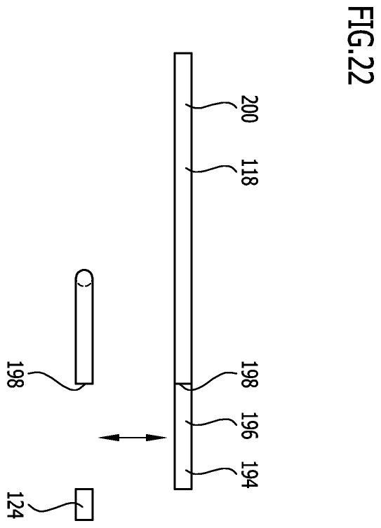

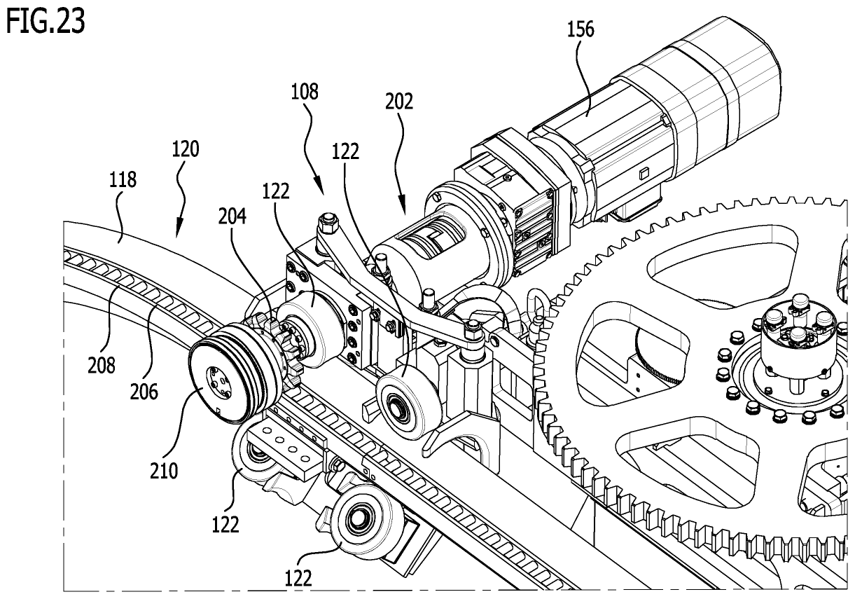

Thus, according to the embodiments in FIGS. 18 through 22, it is provided that the switch element 194 comprise only one path portion 196 which, together with the carriage 108, can selectively be moved into different positions in order to make different paths, and in particular a return path 126 or a maintenance path 200, accessible to the carriage 108 at different connection points 198.

The movement of the switch element 194, and in particular of the path portion 196 together with the carriage 108 arranged thereon, can take place, for example, horizontally (see FIGS. 18 and 19).

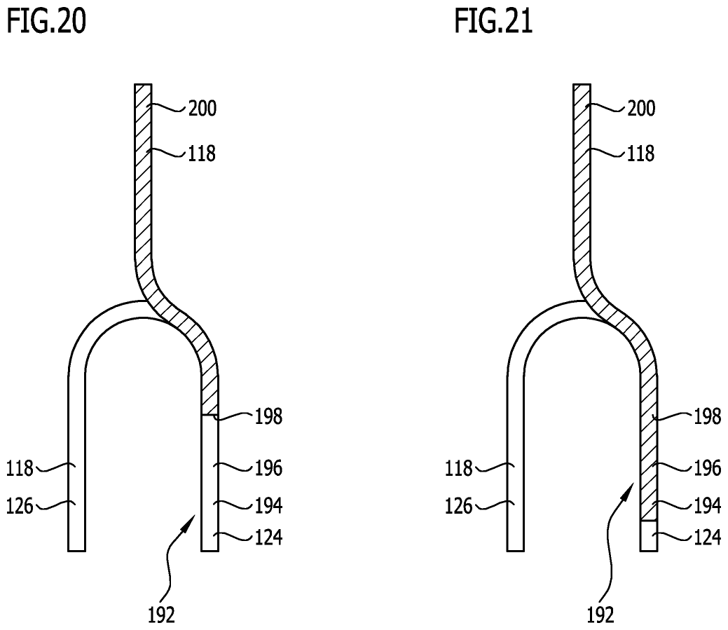

Alternatively, it can be provided that the movement of the switch element 194, and in particular of the path portion 196 together with the carriage 108 arranged thereon, take place, for example, vertically (see FIGS. 20 through 22).

A ninth alternative embodiment of a conveyor device 100 shown in FIG. 23 has a gear drive device 202, which is optional for each of the described embodiments, and which, in particular, enables an optimized climbing travel of the carriage 108, for example, if the guide element 118 of the guide device 120 is not exclusively horizontal.

In principle, the carriage 108 can be driven via one or more driven traction rollers 122. For this purpose, the one or more traction rollers 122 must transmit a force to the guide element 118 by friction. Particularly at the inclined paths of the guide element 118, the friction may be insufficient for the transmission of force. A force transmission, using a positive connection, from a traction drive 156 of the carriage 108 to a suitable counterpart may then be advantageous.

The gear drive device 202 comprises a gearwheel 204 which can be moved into engagement with a counterpart 206, and in particular a drive rack 208, which extends along the guide element 118.

The gearwheel 204 can be coupled to the traction drive 156 in particular by means of a coupling 210. In a horizontal operation of the carriage 108, the gearwheel 204 can be decoupled from the traction drive 156. As soon as the carriage 108 approaches an inclined portion, the gearwheel 204 can be moved into engagement with the counterpart 206, while still preferably turning. The coupling with the traction drive 156 then preferably occurs—in particular, by automatic actuation and/or activation of the coupling 210—in order to subsequently transmit the drive force, required for driving the carriage 108, from the traction drive 156 to the counterpart 206 via the gearwheel 204. The carriage 108 is then moved upwards—for example, along the inclined path.

The gearwheel 204 and the counterpart 206 are preferably sized in such a way that the traction roller 122 rolling on the guide element 118 can be driven without slipping and/or without brakes by means of the traction drive 156 when the gearwheel 204 is coupled. An effective diameter of the gearwheel 204 preferably corresponds to an, in particular, smallest or average diameter of a running surface of the traction roller 122.

Otherwise, the embodiment of the conveyor device 100 shown in FIG. 23 corresponds in terms of structure and function to the embodiment shown in FIGS. 1 through 9, such that reference is made to the above description thereof.

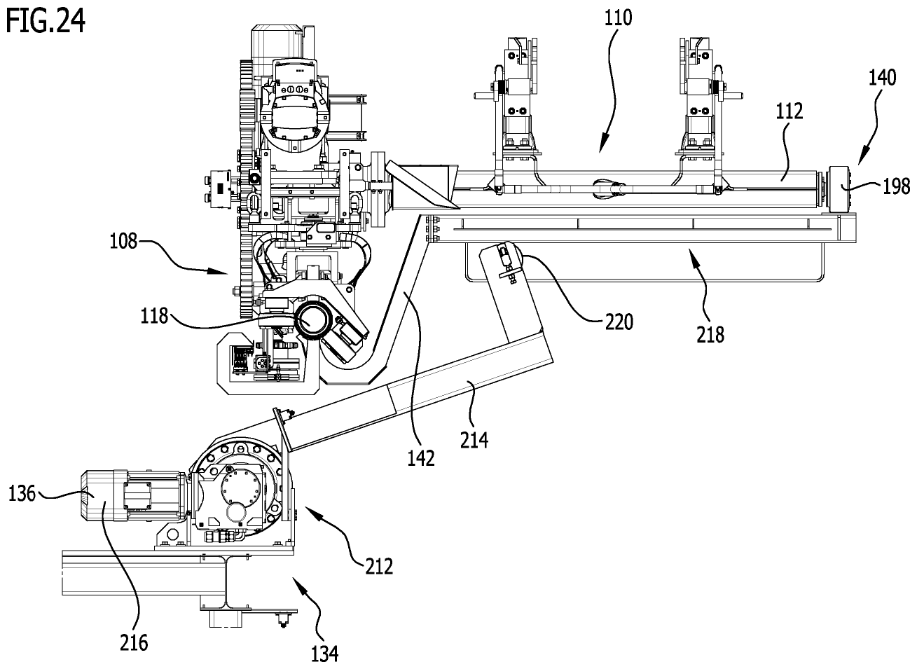

A tenth alternative embodiment of a conveyor device 100 shown in FIG. 24 differs from the embodiment shown in FIGS. 1 through 9 essentially in having a different design of the rotation device 134.

As shown in FIG. 3, the rotary drive 136 serves, for example, for winding and unwinding a tension element used to raise or lower the connecting element 142 together with the pivot plate shaft 112 mounted thereon. In contrast, a lifting arm device 212 is provided, according to FIG. 24.

The lifting arm device 212 comprises in particular a lifting arm 214 which can be raised and lowered by means of a rotary drive 136 designed as a lifting arm drive 216.

The lifting arm 214 engages, with its end remote from the lifting arm drive 216, in particular on a guide portion 218 of a connecting element 142 in order to selectively bring it into a horizontal orientation (receiving orientation) or into a vertical orientation (compact orientation) as shown in FIG. 24.

The end of the lifting arm 214 is provided, for example, with a bearing roller 220 which rolls on the guide portion 218 of the connecting element 142.

The connecting element 142 forms a fixed connection between the guide element 118—in particular, a rotatable guide element portion 144 of the guide element 118—and a support for the counter roller 146. As a result of raising or lowering the lifting arm 214, not only can the guide element portion 144 be rotated as a whole together with the carriage 108 arranged thereon, but also this rotation is assisted by a rotational movement of the support for the counter roller 146. The traction rollers 122 of the carriage 108 therefore do not have to be moved in the circumferential direction relative to the rotatable guide element portion 144, such that friction-related wear can be minimized.

Otherwise, the embodiment of the conveyor device 100 shown in FIG. 24 corresponds in terms of structure and function to the embodiment shown in FIGS. 1 through 9, such that reference is made to the above description thereof.

The lifting arm device 212 illustrated in FIG. 24 is in principle suitable for each of the described conveyor devices 100.

### LIST OF REFERENCE SIGNS

100 Conveyor device
102 Workpiece
104 Vehicle body
106 Treatment system
108 Carriage
110 Workpiece holder
112 Pivot plate shaft
114 Axis of rotation
116 Traction unit
118 Guide element
120 Guide device
122 Traction roller
124 Treatment path
126 Return path
128 Support element
130 Connecting element
132 Rotation position
134 Rotation device
136 Rotary drive
138 Slotted guide
140 End
142 Connecting element
144 Guide element portion
146 Counter roller
148 Support roller
150 Lateral guide roller
152 Stabilizing roller
154 Circumferential direction
156 Traction drive
158 Energy supply device
160 Energy supply element
162 Power rail
164 Energy receiving element
166 Sliding contact
168 Bearing
170 Plain bearing
172 Fixing element
174 Strap
176 Inner side
178 Outer side
180 Height compensation
182 Height adjustment
184 Fixing device
186 Bearing portion
188 Separation line
190 Cover element
192 Switch device
194 Switch element
196 Path portion
198 Connection point
200 Maintenance path
202 Gear drive device
204 Gearwheel
206 Counterpart
208 Drive rack
210 Coupling
212 Lifting arm device
214 Lifting arm
216 Lifting arm drive
218 Guide portion
220 Bearing roller

1. Conveyor device for conveying workpieces—in particular, vehicle bodies—wherein the conveyor device comprises:
at least one carriage for receiving and conveying the workpieces; and
a guide device for guiding the at least one carriage, wherein the guide device includes a guide element on which the at least one carriage is guided in a sliding manner.

2. Conveyor device according to claim 1, wherein the at least one carriage includes one or more traction units, each of the one or more traction units including traction rollers which roll on the guide element of the guide device.

3. Conveyor device according to claim 2, wherein different traction rollers are used to bear the load in different rotational orientations of the carriage, and for lateral guidance along the guide element.

4. Conveyor device according to claim 1, wherein the guide element is a round tube or includes the round tube.

5. Conveyor device according to claim 1, wherein the guide element is a square tube or includes a square tube.

6. Conveyor device according to claim 1, wherein the at least one carriage includes a traction drive and wherein the conveyor device includes an energy supply device for supplying drive energy to the traction drive.

7. Conveyor device according to claim 6, wherein the energy supply device includes an energy supply element which extends along the guide element of the guide device and can be moved into engagement with or is in engagement with an energy receiving element of the carriage.

8. Conveyor device according to claim 7, wherein the energy supply element and/or the energy receiving element can be moved into different rotational orientations or are or can be arranged in different rotational orientations along the guide element—in particular, in such a way that the energy supply element and the energy receiving element can be moved into engagement with one another or are in engagement with one another when the at least one carriage is arranged in a receiving orientation and/or in a compact orientation.

9. Conveyor device according to claim 1, wherein the conveyor device includes a rotation device by which the at least one carriage can be moved into different rotational orientations relative to the guide element.

10. Conveyor device according to claim 9, wherein the at least one carriage can be moved selectively into a receiving orientation and a compact orientation by the rotation device, wherein at least one workpiece can be received and/or conveyed in the receiving orientation by the at least one carriage and/or wherein, in the compact orientation, an extension of the at least one carriage in at least one direction—in particular, in a horizontal direction—is reduced compared to the extension in the receiving orientation.

11. Conveyor device according to claim 9, wherein the rotation device includes a rotary drive or a rotation guide—in particular, a slotted guide—by which the at least one carriage can be moved into different rotational orientations—in particular, by deflecting, raising, or lowering an end, facing away from the guide element, of the at least one carriage and/or by rotating a guide element portion of the guide element.

12. Conveyor device according to claim 1, wherein the guide element includes several guide element portions, wherein one or more of these guide element portions is fixed to support elements of the conveyor device in a rotationally-fixed manner, and wherein at least one guide element portion is to be able to rotate.

13. Conveyor device according to claim 12, wherein the at least one guide element portion is rotatable about its longitudinal axis and/or central axis.

14. Conveyor device according to claim 12, wherein the at least one guide element portion is rotatably mounted, by one or more bearings, including annular bearings, plain bearings, and/or ball bearings, on one or more guide element portions which are rotationally fixed.

15. Conveyor device according to claim 12, wherein the at least one guide element portion which is to be able to rotate forms a rotation position of the conveyor device or is arranged in the rotation position of the conveyor device, wherein, in the rotation position, the at least one carriage can be moved into different rotational orientations relative to the guide element.

16. Treatment system for the treatment of workpieces—in particular, for surface treatment of vehicle bodies—wherein the treatment system includes a conveyor device according to claim 1, wherein the carriage includes a workpiece holder for receiving one or more workpieces, and wherein the workpiece holder is to be rotatable for bringing the one or more workpieces into and out of a treatment container.
